(19) United States
(12) Patent Application Publication
(10) Pub. No.: US 2017/0297427 A1
(43) Pub. Date: Oct. 19, 2017

(54) FLAP WITH INDICATOR MEANS

(71) Applicant: GM GLOBAL TECHNOLOGY OPERATIONS LLC, Detroit, MI (US)

(72) Inventors: Markus FROMMANN, Ruesselsheim (DE); Heiko BETZEN, Ruesselsheim (DE)

(73) Assignee: GM GLOBAL TECHNOLOGY OPERATIONS LLC, Detroit, MI (US)

(21) Appl. No.: 15/489,376

(22) Filed: Apr. 17, 2017

(30) Foreign Application Priority Data
Apr. 15, 2016 (DE) 102016004557.4

(51) Int. Cl. B60K 15/05

(52) U.S. Cl. CPC B60K 15/05; B60K 2015/0546; B60K 2015/0569

(57) ABSTRACT

A flap for a motor vehicle is disclosed which has a side with an actuating region for manually unlocking the flap. An indicator is provided for optically indicating the actuating region on the flap.

### CROSS-REFERENCE TO RELATED APPLICATION

This application claims priority to German Patent Application No. 102016004557.4, filed Apr. 15, 2016, which is incorporated herein by reference in its entirety.

### TECHNICAL FIELD

The present disclosure pertains to a flap with an indicator, a flap arrangement with a flap, a motor vehicle with a flap arrangement, as well as a method for facilitating the manual release of the flap.

### BACKGROUND

Motor vehicle tank flaps are known, which feature a locking mechanism for locking the flap in which the tank flap can be unlocked by manually depressed and subsequently released (“Push & Release”). In this case, the tank flap is preferably unlocked by exerting pressure upon a certain region of the flap. The flap does not open as easily, particularly only with greater effort, or even not at all if pressure is exerted upon another region such as, for example, an incorrect side of a pivoting axis of the flap or the like. This can particularly complicate the actuation of push & release motor vehicle tank flaps by users, who are not familiar with these flaps, for example if the locking mechanism has been modified. Accordingly, there is a need in the art for enhancing the unlocking of a flap.

### SUMMARY

In accordance with the present disclosure, a flap for a motor vehicle is provided and includes a side with a preferably predefined actuating region for manually actuating (i.e., manually unlocking) the flap. An indicator is arranged on the actuating region and respectively is configured for optically indicating or at least temporarily indicating the actuating region. In this way, it is possible to enhance the unlocking of the flap by a user, who is not familiar with a manually unlockable locking mechanism for locking the flap.

In an embodiment, the flap is a tank flap for covering an interface for supplying fuel and/or electrical energy, particularly an electrical interface and/or a tank filler opening, particularly a tank inlet compartment, and/or similar flap of a motor vehicle, particularly a passenger car. In this way, it is possible to enhance the unlocking of the motor vehicle or tank flap by a user, who is not familiar with a manually unlockable locking mechanism for locking the flap.

In an embodiment, the predefined actuating region is a partial region of the side, which is provided for manually actuating or manually unlocking the flap. In particular, the partial region is an area that requires an actuating force for manually actuating or manually unlocking the flap, which amounts to no more than 90%, preferably no more than 75%, particularly no more than 50%, especially no more than 25%, of a maximum actuating force required or to be exerted upon at least another partial region of the side in order to manually unlock the flap. In particular, the region minimizes an actuating force for manually actuating or manually unlocking the flap and/or the region of the side, the manual actuation of which allows or causes the unlocking of the flap, particularly only a part thereof. In this way, it is possible to simplify the unlocking of the flap.

In an embodiment, an indicating surface of the indicator for optically indicating the actuating region and the preferably predefined actuating region overlap one another completely or at least partially. It would be conceivable that the indicating surface includes the actuating region or that the actuating region includes the indicating surface. In an embodiment, the indicating surface of the indicator for optically indicating the actuating region may be ellipsoidal, particularly circular or polygonal, particularly rectangular and/or linear or frame-like or planar, particularly at least essentially circular or annular. In an embodiment, the indicating surface of the indicator for optically indicating the actuating region is respectively defined or bounded by a preferably opaque mask or screen.

In an embodiment, the indication of the actuating region can thereby be enhanced, particularly simplified and/or clarified. In an embodiment, a surface area of the actuating region and/or a surface area or the indicating surface of the indicator for optically indicating the actuating region (respectively) amounts to no more 50%, preferably no more than 25%, particularly no more than 10%, especially no more than 5%, of a surface area of the side.

In an embodiment, the actuating region and/or the indicating surface of the indicator for optically indicating the actuating region additionally or alternatively lie on the side within a circle around a position of a locking element of the flap, such as a latching element thereof, particularly a circle around an axis or a center of gravity of the locking element or its projection on the side. The surface area may amount to no more than 50%, preferably no more than 25%, particularly no more than 10%, especially no more than 5%, of a surface area of the side. In an embodiment, an optical guidance of a user can thereby be enhanced.

In an embodiment, the indicator can be switched over from a first operating mode to a second operating mode for optically indicating the operating region. In an embodiment of the present disclosure, a method is also disclosed to facilitate the manual unlocking of the flap accordingly. An indicator is switched over from a first operating mode to a second operating mode in order to optically indicate the actuating region. In an embodiment of the present disclosure, a flap arrangement with a flap accordingly features a switch for switching over the indicator from the first operating mode to the second operating mode in order to optically indicate the actuating region.

In an embodiment, the actuating region can thereby be indicated as needed and, in particular, the probability of an annoyance due to the unnecessary indication of the actuating region can be reduced. For this purpose, in particular, the actuating region is off or at least essentially not indicated by the indicator in its first operating mode.

In an embodiment, the indicator features a one-piece or multi-piece light source for illuminating, particularly backlighting, the actuating region, particularly only in the second operating mode.

In an embodiment, the actuating region can thereby also be advantageously indicated, in particular, in conditions of poor visibility.

In an embodiment, the light source is arranged beneath or under the side.

In an embodiment, it can thereby be protected from damages and/or arranged compactly.

In an embodiment, the side is optically homogenous during or in the first operating mode of the indicator. Additionally or alternatively, the side is in an embodiment at least partially transilluminated or designed for being partially transilluminated by the indicator during or in the second operating mode thereof. For this purpose, in particular, the side features in an embodiment a preferably colored coating, particularly a paint or plastic coating, the layer thickness and/or structure of which is in an embodiment realized such that the side appears optically homogenous during or in the first operating mode of the indicator and can be at least partially transilluminated by the indicator during or in the second operating mode thereof.

In an embodiment, the probability of an annoyance due to the unnecessary indication of the actuating region can thereby be reduced.

In an embodiment, the light source is deactivated, particularly deenergized, in the first operating mode and activated or designed for being activated, particularly energized, in the second operating mode.

In an embodiment, the actuating region can thereby be indicated as needed and, in particular, the probability of an annoyance due to the unnecessary indication of the actuating region can be reduced.

In an embodiment, the indicator, particularly the light source, remains activated in the second operating mode for a predefined time period and/or until a predefined position of the flap, particularly its completely open position, is reached.

In an embodiment, the flap can thereby be illuminated, particularly while it is opened, in order to thereby facilitate the manual opening of the flap.

In an embodiment, the light source may feature one or more light-emitting diodes (LEDs) and/or be arranged on a printed circuit board and/or on a transparent carrier.

In an embodiment, the actuating region can be advantageously indicated by one or more LEDs in a particularly energy-saving fashion and/or in conditions of poor visibility. A control of the light source can in an embodiment be arranged in a particularly compact and/or protected fashion by a printed circuit board. In an embodiment, a transparent carrier makes it possible to protect and/or enhance the light source with respect to its light emission, particularly such that the light is dispersed, deflected, focused and/or colored.

In an embodiment, the flap features a base body with a recess, in which the indicating surface of the indicator for optically indicating the actuating region is arranged. The base body and the indicating surface are in an embodiment covered by a common and, in particular, homogenous coating of the side.

In an embodiment, the indicating surface can thereby be advantageously protected, particularly from damages, and/or arranged compactly and/or the probability of an annoyance due to the unnecessary indication of the actuating region can be reduced.

According to an embodiment of the present disclosure, the flap is pivotably and/or displaceably mounted on a base of a flap arrangement. In an embodiment, advantageous opening kinematics of the flap can thereby be realized.

The base may in an enhancement feature a tank inlet compartment, particularly form a tank inlet compartment.

In an embodiment, the flap arrangement features a locking mechanism for locking the flap, which can be manually unlocked by manually contacting, particularly exerting pressure, particularly manually depressing, and subsequently releasing the actuating region. It may be realized, in particular, in the form of a push & release locking mechanism and/or feature the locking element.

In an embodiment, the indicator is switched over from the first operating mode to the second operating mode, in particular, when or in case an intention to unlock the flap is detected. An intention to unlock the flap is in an enhancement detected, particularly predicted, for this purpose. In an embodiment of the method an intention to unlock the flap is detected and the indicator is switches over from the first operating mode to the second operating mode, in particular, when or in case an intention to unlock the flap or the flap arrangement is detected. A prediction device is provided to detect an intention to unlock the flap and the switch is provided for switching over the indicator from the first operating mode to the second operating mode, in particular, when or in case an intention to unlock the flap is detected.

In an embodiment, the actuating region can thereby be indicated as needed and, in particular, the probability of an annoyance due to the unnecessary indication of the actuating region can be reduced.

In an embodiment, an intention to unlock the flap is detected, in particular, when or in case at least one motion and/or proximity sensor, for example at least one capacitive, ultrasonic, infrared or radar sensor and/or at least one camera, detects that a hand approaches the side. In an embodiment of the method a hand that approaches the side may be detected, particularly by at least one motion and/or proximity sensor, particularly at least one capacitive, ultrasonic, infrared or radar sensor and/or by at least one camera, and thereby detecting an intention to unlock the flap. The prediction device features a detector for detecting when a hand approaches the side in order to thereby detect the intention to unlock the flap. The detector particularly features at least one motion and/or proximity sensor, particularly at least one capacitive, ultrasonic, infrared or radar sensor and/or at least one camera. In an embodiment, the intention to unlock the flap is detected, particularly when or in case an approaching hand is detected, once the detected approach of the hand to the side exceeds a predefined limiting value, particularly when a detected distance of the hand from the side falls short of a predefined limiting value.

In an embodiment, it is thereby advantageously possible to detect and react to the need to indicate the actuating region in a particularly fast and/or reliable fashion and/or to reduce the probability of an annoyance due to the unnecessary indication of the actuating region.

A means or device may, in the context of the present disclosure, be realized in the form of hardware and/or software technology, particularly a digital processor unit that is preferably connected to a storage and/or bus system via a data or signal link, particularly a microprocessor unit (CPU), and/or features one or more programs or program modules. The CPU may be designed for processing commands that are implemented in the form of a program stored in a storage system, for receiving input signals from a data bus and/or delivering output signals to a data bus. A storage system may feature one or more storage mediums, particularly different storage medium such as optical, magnetic, solid-state and/or other non-volatile mediums. The program may be realized in such a way that it respectively embodies or is capable of carrying out the methods described herein such that the CPU can carry out the steps of these methods.

In an embodiment, one or more steps of the method, particularly all steps, are carried out in a completely or partially automated fashion, particularly by the control of the flap arrangement.

### BRIEF DESCRIPTION OF THE DRAWINGS

The present disclosure will hereinafter be described in conjunction with the following drawing figures, wherein like numerals denote like elements.

FIG. 1 shows a flap arrangement with a tank flap of a motor vehicle according to an embodiment of the present disclosure;

FIG. 2 shows the flap with indicated actuating region;

FIG. 3 shows a section through the flap with an enlarged detail; and

FIG. 4 shows a method for facilitating the manual unlocking of the flap according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

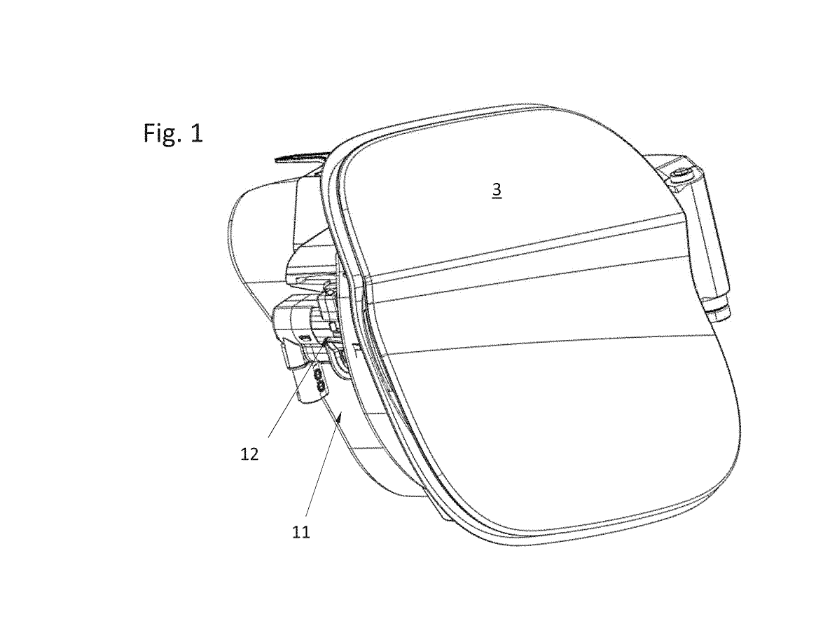

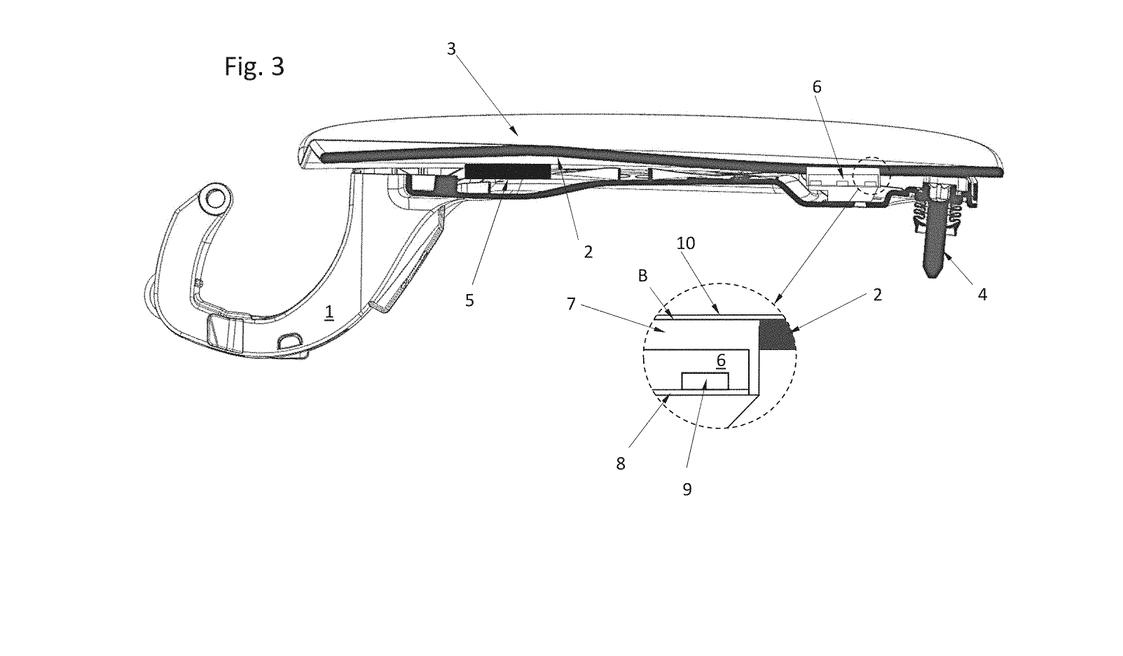

FIG. 1 shows a flap arrangement with a tank flap 3 of a motor vehicle according to an embodiment of the present disclosure. The flap arrangement is pivotably mounted on a base 11 by a hinge arm 1 (see FIG. 3).

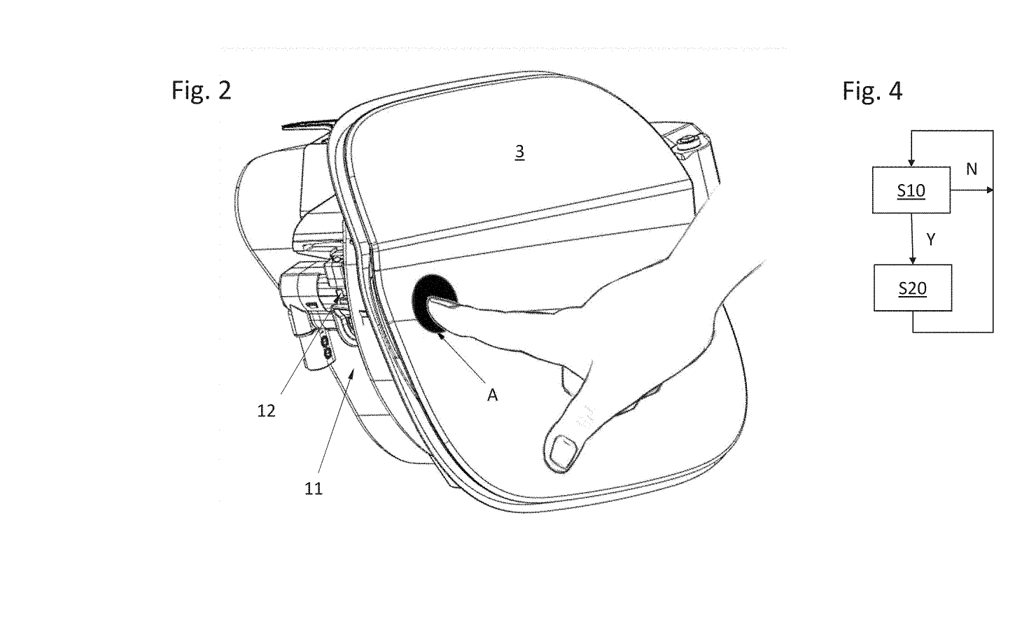

The flap arrangement features a locking mechanism 12 with a locking or latching element 4 (see FIG. 3) that is arranged on and serves for locking the flap 3. The locking mechanism can be unlocked by manually depressing and subsequently releasing an actuating region A (see FIG. 2) on a front side of the flap 3 in FIG. 1.

The flap 3 features an indicator 6 (see FIG. 6) for optically indicating the actuating region A. The indicator 6 is arranged on this actuating region A and can be switched over from a first operating mode illustrated in FIG. 1 to a second operating mode illustrated in FIG. 2 in order to optically indicate the actuating region. The indicator 6 features a multi-piece light source in the form of multiple LEDs 9 for backlighting the actuating region A (see FIG. 3). These LEDs are arranged on a printed circuit board 8 and in a transparent carrier 7, which in turn is arranged in a recess of a base body 2 of the flap 3.

The side with the actuating region A features a paint or plastic coating 10 that homogenously covers the base body 2 and an indicating surface of the indicator 6 in the form of a front side B of the transparent carrier 7. This coating is sufficiently thin that it is transilluminated by the activated LEDs 9 as indicated in FIG. 2.

The flap arrangement features a prediction device with a detector in the form of a proximity sensor 5 for detecting when a hand approaches the side in order to thereby detect an intention to unlock the flap, as well as a switch in the form of a control that is integrated into the printed circuit board 8 and serves for switching over the indicator 6 from a first operating mode to a second operating mode based on a detected intention to unlock the flap.

The prediction device detects an intention to unlock the flap 3 if the proximity sensor 5 detects in step S10 (see FIG. 4) that a hand approaches the side, particularly that the distance of a hand from the side falls short of a predefined limiting value (S10 “Y”). The control subsequently switches the indicator 6 from the first operating mode into the second operating mode, in which it energizes the LEDs 9, in step S20. These LEDs then partially transilluminate the side and thereby optically indicate the actuating region A (see FIG. 2).

The LEDs 9 may remain energized during the entire opening process of the flap.

Subsequently, the method once again returns to step S10 and the indicator 6 is switched back to its first operating mode. In this operating mode, the side is optically homogenous due to the now deenergized LEDs and the uniform layer 10.

According to FIG. 2, a surface area of the actuating region A and a surface area of the indicating surface B respectively amount to no more than 50% of a surface area of the side and are arranged in the immediate vicinity of the locking element 4.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A flap arrangement for a motor vehicle comprising:
a flap displaceable with respect to the motor vehicle, the flap having an actuating region on an outer surface for manually unlocking the flap; and
an indicator positioned beneath the actuating region and operably for optically indicating the actuating region at the outer surface.

17. The flap according to claim 16, wherein the indicator is switchable between a first operating mode wherein the actuating region is not indicated and a second operating mode wherein the actuating region is optically indicated.

18. The flap according to claim 16, wherein the indicator comprises a light source configured to backlight the actuating region.

19. The flap according to claim 16, wherein the light source comprises a light emitting diode.

20. The flap according to claim 18, wherein the light source is deactivated in the first operating mode and activated in the second operating mode.

21. The flap according to claim 18, wherein the light source is arranged underneath the outer surface such that the flap is optically homogenous in the first operating mode and at least partially transilluminated by the light source in the second operating mode.

22. The flap according to claim 16, wherein a surface area of the actuating region and an indicating surface of the indicator amounts to no more than 50% of a surface area of the side.

23. The flap according to claim 16, further comprising a locking element, wherein the actuating region and an indicating surface of the indicator lies on the side within a circle around a position of the locking element and amounts to no more than 50% of a surface area of the side.

24. The flap according to claim 16, wherein the flap comprises a tank flap for covering an interface for supplying at least one of fuel or electrical energy.

25. A flap arrangement according to claim 16, further comprising a base on which the flap is pivotably mounted.

26. The flap arrangement according to claim 25, further comprising a locking mechanism for locking the flap, wherein said locking mechanism is configured to unlock by manually depressing and subsequently releasing the actuating region.

27. The flap arrangement according to claim 25, further comprising a prediction device configured to detect an intention to unlock the flap and a switch configured to switch the indicator from a first operating mode wherein the actuating region is not indicated to a second operating mode wherein the actuating region is optically indicated based on a detected intention to unlock the flap.

28. The flap arrangement according to claim 27, wherein the prediction device comprises a detector configured to detect a hand approaching the side thereby indicating an intention to unlock the flap.

29. The flap arrangement according to claim 28, wherein the detector is selected from the group consisting of a motion sensor, a proximity sensor, a capacitive touch sensor, an ultrasonic sensor, an infrared sensor, a radar sensor or a camera.

30. A motor vehicle comprising a vehicle body with a flap arrangement according to claim 16.

31. A method for facilitating the manual unlocking of a flap comprising:
providing a flap arrangement for a motor vehicle having a flap displaceable with respect to the motor vehicle, the flap having an actuating region on an outer surface for manually unlocking the flap, and an indicator positioned beneath the actuating region and operably for optically indicating the actuating region at the outer surface;
detected an intention to unlock the flap; and
switching the indicator from a first operating mode wherein the actuating region is not indicated to a second operating mode wherein the actuating region is optically indicated based on the detected intention to unlock the flap.

32. The method according to claim 31 further comprising:
detecting when a hand approaches the side; and
detecting the intention to unlock the flap based on a detected approach.
